(19) United States
(12) Patent Application Publication
(10) Pub. No.: US 2008/0040967 A1
(43) Pub. Date: Feb. 21, 2008

(54) Bug trap device

(76) Inventor: Todd M. Young, Stafford, VA (US)

Correspondence Address: KLIMA LAW OFFICES, P.L.L.C., P.O. Box 2855, Stafford, VA, 22555-2855, US

(21) Appl. No.: 11/504,051

(22) Filed: Aug. 15, 2006

(51) Int. Cl. A01M 3/04; A01M 1/14

(52) U.S. Cl. 43/136; 43/114

(57) ABSTRACT

A bug trap device for capturing bugs or insects in midair or resting on a surface. The entire bug trap device can be disposable, or a portion thereof. A preferred embodiment utilizes a reusable handle and a disposable insert.

### FIELD OF THE INVENTION

The present invention is directed to a bug trap device, in particular a bug trap device configured to trap and eliminate bugs or insects, particularly in the household or workplace.

### BACKGROUND OF THE INVENTION

There exist devices for catching and/or disposing of bugs. For example, a fly swatter is design to hit a fly or flying insect that has landed on a surface such as a countertop, desktop, wall, floor or ceiling. The fly swatter, however, can mess, damage, stain, soil or otherwise compromise the surface due to the bug or insect being smashed into the surface by the fly swatter.

There exist a number of insect sprays that are sprayed onto surfaces to kill a variety of types of insects. However, the insect sprays tend to be messy, may damage or stain surfaces, and are potentially toxic or harmful to people.

There exists a need for a bug trap device that is simple, easy and convenient to use. Further, there exists a need for a hand held bug trap device that allows a user to immediately pursue a bug flying around or located on a surface in a safe and efficient manner. The bug trap device according to the present invention is such a device.

### SUMMARY OF THE INVENTION

A first object of the present invention is to provide an improved bug trap device.

A second object of the present invention is to provide a bug trap device including a handle portion connected to a trap portion.

A third object of the present invention is to provide a bug trap device including a handle portion connected to a lid-shaped trap portion.

A fourth object of the present invention is to provide a bug trap device including a handle portion connected to a trap portion having a sticky material or substance associated with the bug trap device.

A fifth object of the present invention is to provide a bug trap device including a handle portion and trap portion having a bug receiver.

A sixth object of the present invention is to provide a bug trap device including a handle portion and trap portion having an opening for receiving the bug.

A seventh object of the present invention is to provide a bug trap device including a handle portion connected to a trap portion having at least one inner surface provided with sticky material.

A eighth object of the present invention is to provide a bug trap device including a handle portion connected to a trap portion having a layer of sticky material disposed therein.

A ninth object of the present invention is to provide a bug trap device including a handle portion connected to a trap portion including a sticky mass disposed therein.

A tenth object of the present invention is to provide a bug trap device including a handle portion connected to a trap portion including a sticky insert disposed therein.

A eleventh object of the present invention is to provide a bug trap device including a handle portion connected to a trap portion having a trap door.

A twelfth object of the present invention is to provide a bug trap device including a handle portion connected to a trap portion having a slidable trap door.

A thirteenth object of the present invention is to provide a bug trap device including a handle portion connected to a trap portion having a spring biased slidable trap door actuated by a finger grip on the handle portion.

The present invention is directed to a bug trap device for catching and disposing of bugs or insects. The bug trap device includes a handle portion connected to a trap portion. The handle allows a user to grip one end of the handle and remotely manipulate the trap portion connected to an opposite end of the handle. The length of the handle can be selected to be shorter for close in work around kitchen and bathroom surfaces (e.g. like feather duster or like Swifter duster), or can be longer for reaching bugs or insects on floor, wall, door, or ceiling surfaces. Further, a longer handle allows the user to be at a safe distance from the bug or insect types that can sting or bite the user (e.g. bees, wasps, hornets, spiders, fire ants or other biting or stinging insects).

In a preferred embodiment, the handle is connected to the bug trap so that the handle is inclined relative to the bug trap. This arrangement allows a user to easily and accurately position the bug trap against a floor, wall, door, counter top, desktop or ceiling surface while also viewing the bug or insect to be trapped. The handle can be a one-piece construction (e.g. injection molded plastic), a telescoping handle (e.g. slidable metal or plastic telescoping sections), or can be multiple pieces to be assembled together (e.g. to facilitate small packaging of bug trap device) A preferred embodiment of the trap portion is a lid-shaped trap portion. In this embodiment, the handle can be connected to an upper or side wall portion of the lid-shaped trap, again preferably at an inclined angle.

The preferred lid-shaped trap portion is provided with a lower rim to trap and make contact with the surface on which the bug is located on. The upper wall portion and side wall portions of the lid-shaped trap portion, when positioned over a bug, traps the bug between the trap portion and the surface. Specifically, the lower rim of the trap portion is positioned over the bug and then in contact with the surface to prevent escape of the bug or insect. The lower rim of the trap portion can be made to be soft or otherwise made of a material so as to not damage the surface (e.g. tile, wood, plaster, wall board, paint, cloth, fabric, felt, carpet, glass, metal or other common household or workplace surfaces).

The handle portion can be made of wood, plastic, injection molded plastic, extruded plastic, fiberglass, graphite, composite, ceramic, metal, combination of materials or other suitable material. The trap portion can be made of cardboard, molded paper pulp, molded cardboard, plastic, molded plastic, injection molded plastic, vacuum molded plastic, extrusion molded plastic, cast plastic resin, molded plastic sheet, wood, metal, composite, combination of materials or other suitable material.

In another preferred embodiment, the handle portion and trap portion are made as a one-piece construction (e.g. injected molded plastic piece). In a further preferred embodiment, the handle portion is made of one material and the trap portion is made of another material (e.g. injection molded handle connected to a vacuumed formed plastic trap portion, plastic injection molded handle portion and plastic injection molded trap portion configured to snap-fit or interference fit together).

The bug trap device according to the present invention preferably includes a bug retainer associated with or connected to the bug trap device. The bug retainer is preferably disposed within and trap portion, and configured to retain the bug or insect within trap portion after a bug is covered or trapped by the trap portion. The bug retainer can be a mechanical device (e.g. trap door, specifically a slidable trap door), or can be a fixed or non-movable type (e.g. sticky material or substance disposed within trap portion).

An embodiment of the bug trap device incorporating a trap door according to the present invention is preferably configured so that the trap door opens and closes an opening into the trap portion. For example, a slidable trap door is provided or associated with the trap portion and/or handle portion of the bug trap device. The slidable trap door is configured to move adjacent or on the lower rim of a lid-shaped trap portion to open and close the opening defined by the lower rim. The trap door can be spring biased to close or open the slidable trap door depending on a particular design. Preferably, a finger grip or trigger is provided on the handle portion and configured to actuate the slidable trap door to open and close. For example, a wire or plastic push rod can be connected to the finger trigger, and the slidable trap door is actuated by same. In this manner, a user can trap a bug by covering the bug against a surface with the trap portion and then closing the slidable trap door to enclose the bug within the trap portion.

In a most preferred embodiment, the bug trap device is a solid state or otherwise fixed device having no movable parts, and simple in construction. In one version, the handle portion and the trap portion are made as a single piece or assembled to be a unit, and the bug retainer is replaceable or disposable. In another version of this embodiment, the handle portion is reusable and the trap portion or a portion of the trap portion (e.g. insert) is disposable. For example, a releasable connection is provided between the handle portion and trap portion so that the trap portion can be disposed of after catching or trapping one or more insects at one time or at subsequent times. For example, a snap fit connection, interference fit connection, adhesive connection or some other suitable mechanical connection is provided between the handle portion unit and the trap portion unit so that the trap portion unit can be replaced and disposed of repeatedly. Alternatively, a disposable insert is used with the trap portion.

In the disposable trap portion or disposable insert, the trap portion can be provided with a sticky material or substance associated with the trap portion. The sticky substance can be located on one or more exterior surface, but more preferably is located on one or more interior surfaces of the trap portion. For example, a layer of sticky material such as used in conventional strip type fly catchers can be applied to one or more inner surfaces of the trap portion. Alternatively, a sticky mass (e.g. molded sticky mass) is applied to one or more surfaces of the trap portion, in particular on the inside of the trap portion. The sticky mass is preferably a three-dimensional sticky mass having both significant length and height dimensions so as to occupy a portion of volume within the trap portion so that when a bug is covered by the trap portion and against a surface, the bug makes contact with the sticky mass and is adhered thereto. In some embodiments, the sticky mass is sized and shaped so that the insect is pressed between the sticky mass and the surface to ensure good adhesion to the bug or insect. Further, the sticky mass can be provided with projections (e.g. fingers) or holes to again facilitate gripping and adhesively securing the bug or insect thereto within the confines of the trap portion. Even further, a sticky layer can be provided within the trap portion again to contact or adhere the bug or insect thereto.

In the most preferred embodiment, a trap door is not required since the bug or insect is adequately adhered to the inside of the trap portion having being caught. The trap portion can be configured so that one or more bugs can be adhered at one time (i.e. simultaneously) or sequentially prior to disposal of the trap portion or a disposable portion of the trap portion (e.g. insert). The use of a sticky material or substance can eliminate the need for a trap door and eliminates need for any moving parts.

Optionally, the bug trap device can be provided with an insecticide to kill the bug or insect and ensure disposal thereof. For example, the insecticide can be provided within the trap portion so that once the bug or insect is trapped it will soon or immediately be killed by the insecticide when placed in contact therewith. In a preferred embodiment, the insecticide is attached to or formulated with the sticky material or substance so that when the bug or insect becomes adhered to the sticky materials or substance, the bug or insect is quickly killed by the insecticide associated or contained therein. In this manner, the disposable trap device or disposable portion of the trap portion can be discarded into a waste can or container for final disposal.

In a particularly preferred embodiment, a plastic injection molded handle and trap portion are made as a single piece, reusable plastic article. A disposable insert such as a vacuumed formed plastic sheet tray insert containing sticky substance or material is releaseably adhered within the trap portion of the bug trap device. Once the tray insert is loaded into the trap portion, the bug trap device is ready for use. After one or more bugs have been trapped and stuck to the sticky material or substance disposed within the tray insert, the tray insert is removed from the trap portion and discarded. The vacuumed formed plastic sheet tray insert can be packaged as a single unit or multiple units, can come as a strip of plastic tray inserts, can come as a matrix of plastic tray inserts that can be subsequently separated by tearing or cutting. Preferably, the plastic tray or trays are covered by a thin plastic or foil or composite film acting as a releasable seal covering the sticky layer while being packaged to maintain the activity of the sticky material and/or insecticide material.

### BRIEF DESCRIPTION OF THE DRAWINGS

FIG. 1 is a perspective view of a preferred embodiment of the bug trap device according to the present invention.

FIG. 2 is a side elevational view of the bug trap device shown in FIG. 1.

FIG. 3 is a bottom planar view of the bug trap device shown in FIG. 1.

FIG. 4 is a traversed cross-sectional view of the bug trap device as indicated in FIG. 3.

FIG. 5, is a partial broken away side elevational view of the bug trap device according to the present invention with the insert positioned below the trap portion prior to assembly.

FIG. 6 is a perspective view of the tray insert shown in FIG. 5 turned upside down.

FIG. 7 is a perspective view of the tray insert shown in FIG. 5.

FIG. 8 is a perspective view of the tray insert shown in FIG. 6 provided with a removable seal.

FIG. 9 is a perspective view of the tray insert shown in FIG. 7 with a removable protective layer over the adhesive dot.

FIG. 10 is a top planar view of another preferred embodiment of the bug trap device according to the present invention.

FIG. 11 is a perspective view of a further preferred embodiment of the bug trap device according to the present invention.

FIG. 12 is a longitudinal horizontal cross-sectional view of the bug trap device shown in FIG. 11.

FIG. 13 is a partial broken away bottom planar view of the bug trap device shown in FIG. 11.

FIG. 14 is a partial broken away bottom planar view of the bug trap device shown in FIG. 11 provided with a sticky mass in the trap portion.

### DETAILED DESCRIPTION OF PREFERRED EMBODIMENTS

A preferred embodiment of the bug trap device 10 according to the present invention is shown in FIGS. 1-9.

The bug trap device 10 includes a handle portion 12 and a trap portion 14 connected together. The handle portion 12 and the trap portion 14 can be made as a single piece (e.g. injection molded plastic), or can be made as separate units and then assembled together.

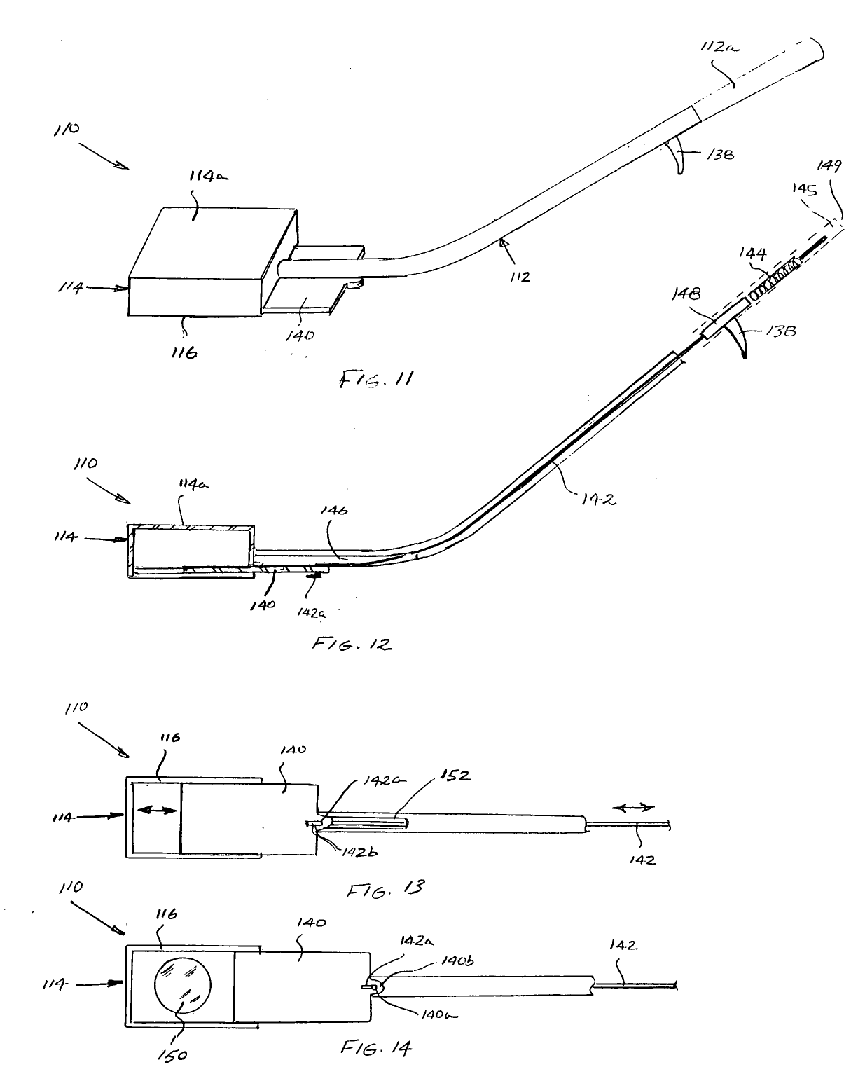

The handle portion 12 can be made to have various lengths. For close in work, a short handle large enough to accommodate a user's hand can be selected. For other applications requiring a longer reach, the handle portion 12 can be of a longer length (e.g. 1-25 feet in length). Even further, the handle portion 12 can be a telescoping handle portion 12a′, as shown in the embodiment of FIG. 10 to allow the length to be varied, in particular to allow the length to be increased.

The trap portion 14 shown is a lid-shaped trap portion 14. The lid-shaped trap portion 14 has a lower edge 16 including a forward edge portion 16a, rear edge portion 16b, and two (2) side edge portions 16c. The lid-shaped trap portion 14 includes an upper wall portion 14a, front wall portion 14b, rear wall portion 14c, and side wall portions 14d defining a receiver 18 (See FIG. 5).

A preferred embodiment of the bug trap device 10 shown in FIG. 1 includes an insert 20, preferably a disposable insert. The details of the insert 20 will be described below. It is to be noted that the bug trap device 10 shown in FIG. 1 can be utilized without the insert 20 by providing a sticky material or substance within the receiver 20 of the trap portion 14 instead of the insert 20. For example, in this arrangement the entire bug trap device 10 can be disposable after the sticky substance or material becomes covered by bugs or insects. Alternatively, the sticky substance or material (e.g. sticky layer or mass) can be disposable to allow reuse of the bug trap device 10. The most preferred embodiment is to provide the disposable insert 20 with a reusable handle portion 12 and trap portion 14 for added convenience making it easy to replace the sticky layer or sticky mass without touching same by the user. For example, the handle portion 12 and trap portion 14 can be a single piece plastic injection molded unit that is reusable, and the insert 20 can be a vacuumed formed plastic sheet material tray configured to fit within the receiver 18 of the trap portion 14 and to be described in detail below.

The handle portion 12 and trap portion 14 can be made as a single piece (e.g. injection molded unit), or alternatively can be made as separate pieces and then assembled or connected together (e.g. adhered, mechanically fastened, heat welded, snap fit connection, slide connection). The handle portion 12 and trap portion 14 are preferably made of plastic material (e.g. plastic injection molded unit), however, other materials such as wood, metal, composite, fiber glass, Kevlar, carbon fiber, cardboard, cardboard composite or other suitable material can be utilized for making the handle portion 12 and/or trap portion 14).

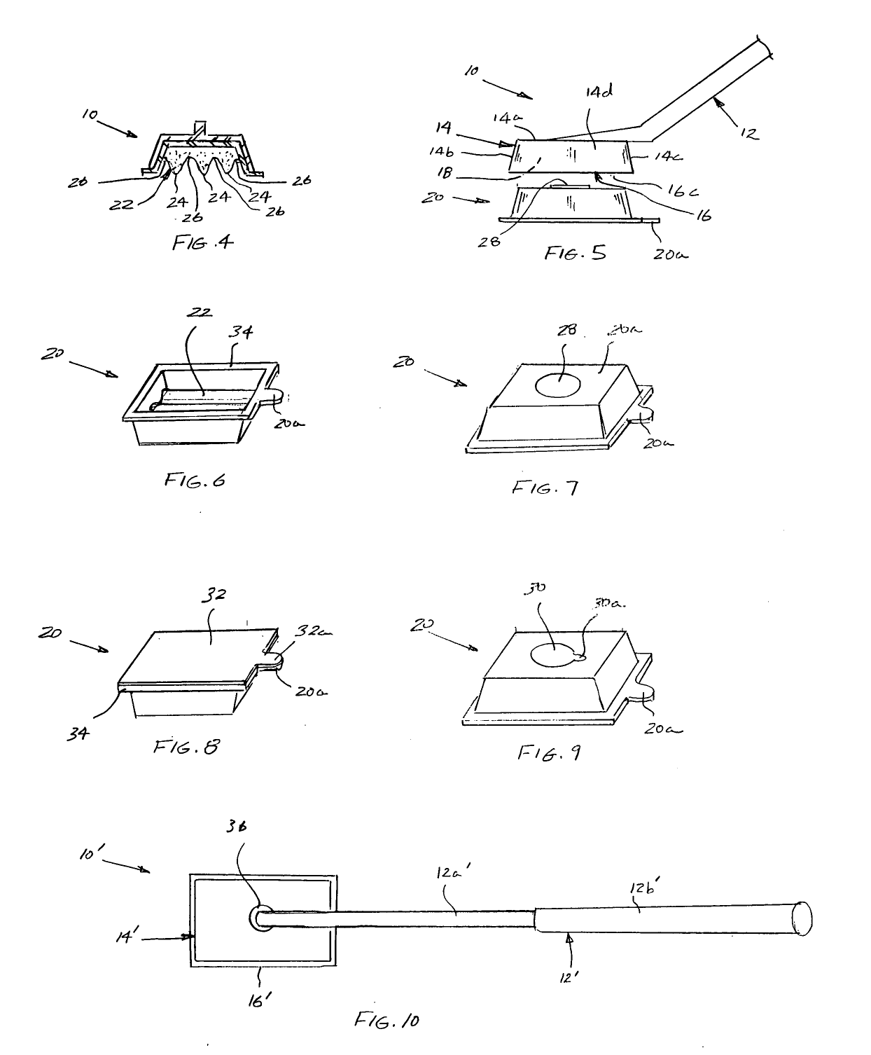

The insert 20, as shown in FIG. 6, is like a small tray (when turned upside down for filling with a sticky mass or sticky layer). The insert 20 is sized and shaped to nest within the receiver 18 of the bug trap device 10. The insert 20 is provided with a sticky material or substance, preferably a sticky layer 22. This sticky layer 22 is preferably provided with a plurality of protrusions or ridges 24 having valleys 26 disposed therebetween. When the trap portion 14 is positioned over a bug or insect resting on a surface, using handle 12, and then pressed against the surface (e.g. floor, wall, counter top, door, ceiling), the bug or insect is then trapped between the trap portion 14 and the surface causing the bug to contact with the sticky layer 22. Further, the bug or insect would tend to be forced between a pair of adjacent protrusions or ridges 24 into one of the valleys 26 further contacting and adhering the bug or insect to the sticky layer 22. In some instances, depending on the particular composition of the sticky layer 22, the bug is at least partially pressed into the sticky layer to positively adhere same thereto. Instead of the protrusions or ridges 24 as shown, the protrusions or ridges 24 can be changed to be finger-like protrusions or otherwise a matrix of protrusions to provide two-dimensional protrusions or ridges and valleys.

The insert 20 is preferably disposal and made of an inexpensive material such as a paper/cardboard product or plastic material. For example, the insert 20 is made by vacuuming forming a sheet of plastic material (e.g. polystyrene) to form a lid-shaped article (when positioned upright) or a tray-like article (when turned upside down). Alternatively, the insert 20 in injection molded of plastic material (e.g. polyethylene, polypropylene). The insert 20 is provided with a tab 20a to allow a user to grip same when removing the insert 20 from the tray-like trap portion 14. An adhesive such as an adhesive dot 28 is applied to an upper wall portion 20a of the insert 20, as shown in FIG. 7. The adhesive dot 28 is made of a contact adhesive formulated to removably adhere and secure the insert 20 within the trap portion 14 of the bug trap device 10, as shown in FIG. 5. Specifically, the adhesive dot 28 is pressed in contact with the inner surface of the upper wall portion 14a of the trap portion 14 to secure the tray 20 therein prior to use. The adhesive dot 28 can be provided with a removable protective layer 30 having a tap 30a to facilitate removal, as shown in FIG. 9. The strength of the contact adhesive is preferably formulate to provide adequate to good securing of the insert 20 within the tray-like trap portion 14, but still allow easy removal by a user's finger grapping and pulling on tab 20a to facilitate replacement of the insert 20.

In a preferred embodiment of the tray 20, a protective seal 32 (e.g. thin plastic film and/or foil) is applied to a lower rim 34 of the insert 20, as shown in FIG. 8. The seal 32 can be applied by adhesive, welding, heat welding, inductive welding, and/or thermal application (e.g. hot sealing), or by some other suitable method. The insert 20 can be assembled by initially molding the tray-like article, and then filling the tray-like article with adhesive material or substance, preferably also including an insecticide, and then sealing the lower rim 34 with the seal 32. In this manner, the freshness, dryness, cleanliness, and activity of the adhesive layer and insecticide is/are maintained to provide long shelf life.

The insert 20 can be packaged as a single unit, for example, in a cardboard display box or plastic display package. Alternatively, a plurality of inserts 20 can be packaged together in a single box or container or packaging. In another embodiment, a plurality of inserts 20 come in a strip or matrix arrangement configure to be torn apart (e.g. frangible sheet material or connection between adjacent inserts 20), or by cutting (e.g. using a scissors).

The bug trap device 10 is used by initially removing the protective layer 30 (FIG. 9) to expose the adhesive dot 28 (FIG. 7), and then the insert 20 is loaded into the receiver 18 of the trap portion 14. The adhesive dot 28 securely adheres the insert 20 to an upper surface of the upper wall portion 14a of the trap portion 14 when fully nested therein. The user then removes the protective seal 32 by gripping tap 32a, and then pulling the protective layer 30 away from the tray-like insert 20. The bug trap device 10 is now ready to capture and trap a bug or insect in midair or on lying on a surface.

The trap portion 14 is shown to be a lid-shaped article, however, other suitable two (2) and three (3) dimensional shapes such as circular, triangular, square, rectangular, cylinder, box, symmetric, asymmetric) can be utilized in some applications. It is noted that the lid-shaped trap portion 14 is particularly useful for most applications including getting into square corners for trapping bugs or insects. The insert 20 is preferably made of a fairly soft non-abrasive material to prevent inadvertent scuffing, mars, scratches or otherwise damage to the surface(s) on which bugs or insects may be found.

Another embodiment of the bug trap device 10′ according to the present invention is shown in FIG. 10.

The bug trap device 10′ includes a telescoping handle 12′ including a first handle section 12a′ and a second handle section 12b′. Additional telescoping sections may be added to increase the overall length of the handle 12′. Alternatively, the handle 12′ can be made of two or more fixed length sections (e.g. handle sections 12a′ and 12b′) that are connected together for assembly purposes (e.g. to reduce size of packaging), and may or may not be also adjustable in length. A further feature of this embodiment includes a swivel joint 36 (e.g. ball joint) connecting the handle portion 12′ to the trap portion 14′. The swivel joint 36 allows the angle of the handle 12′ to change relative to the trap portion 14′ to provide greater flexibility and freedom of use of the device.

A further embodiment of the bug trap device 100 according to the present invention is shown in FIGS. 11-14.

The bug trap device 110 includes a handle portion 112 and trap portion 114 connected together. The handle portion 112 includes a finger trigger connected to a slidable trap door 140 to actuate same (i.e. open and close). Specifically, a bendable wire 142 mechanically connects the trigger 138 to the slidable trap door 140 so that the trigger 138 actuates the slidable trap door 140 to open and close the trap portion 114. A spring 144 (e.g. coil spring) is provided within a passageway 145 (FIG. 12) in a handgrip portion 112a of the handle 112. Specifically, the length of the handle 112 is provided with a through passageway 146 for accommodating the bendable wire 142, and the hand grip portion 112a of the handle 112 is provided with the passageway 145 for slidably accommodating a slidable guide 148 of trigger 138 and coil spring 144. The passageways 145 and 146 preferably communicate or are contiguous with each other. A stop 149 in the hand grip 112a traps the upper end of the coil spring 144 so as to exert a spring bias against the slidable guide 148, which in turn forces the bendable wire 142 in a direction so as to close the slidable trap door 140 of the trap portion 114.

The bendable wire 142 can be replaced with a bendable push rod, linkage or other suitable mechanical device. In the embodiment shown, the bendable wire 142 is provided with a bent end 142a extending through a through hole 140a of tab 140b of the slidable trap door 140. An opposite end of the bendable wire 142 is fastened to the slidable guide 148 of trigger 138 (e.g. by insert molding, heat welding, adhering, mechanically fastening or other suitable method).

The bug trap device 110 can operate without the use of any sticky substance or material due to the existence of the slidable trap door 140 allowing the user to selectively open and close the trap device 114 to capture the bug or insect. Alternatively, the bug trap device can be combined with sticky substance or mass to enhance performance (e.g. round button 148 is provided within the trap portion 114, shown in FIG. 14). The sticky mass 148 can contact with the trapped bug or insect to further trap and secure the bug or insect. In use, the slidable trap door 140 is opened and then the trap portion 114 is positioned over the bug or insect on a surface. The slidable trap door is opened by pulling on the trigger 138. The slidable trap door 140 is then closed by releasing the trigger 138 to trap the bug or insect inside the trap portion 114. Thus, in the embodiment shown in FIGS. 11-14, the slidable trap door 140 is spring biased to a closed position. Alternatively, the bug trap device can be configured so that the slidable trap door 140 can be spring biased to an open position.

The handle 142 is provided with a through slot 150 on a lower side of the handle 142, as shown in FIG. 13. The slot 150 allows the bendable wire 142 to exit out of the passageway 146 in the handle portion 142 and connect to tab 140b of slidabe trap door 140.

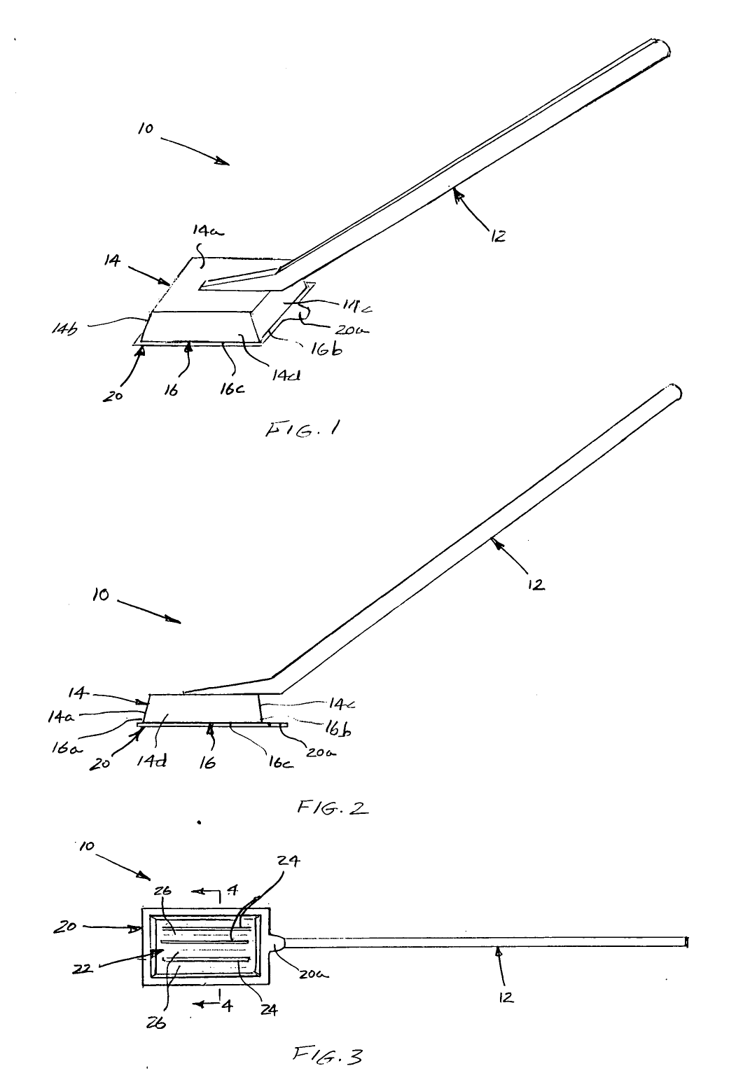

The sticky layer 22 in the embodiment shown in FIG. 3, and the sticky mass 150 in the embodiment shown in FIG. 14 can be replaced with other arrangements or configurations of sticky material or substance. For example, a sticky layer can be applied to one or more surfaces located on the interior of the trap portion 14, 114. Further a sticky mass having a matrix of holes therein can be utilized to facilitate capturing bugs or insects in the depth of the sticky mass.

Preferably, the sticky mass is located above the lower rim 14a, 114a of the trap portion 14, 114 so that the sticky material or substance does not come into contact with the surface on which the bug is located. This prevents the sticky material or substance from being transferred to the surface.

Optionally, the bug trap device according to the present invention is provided with an insecticide, preferably an insecticide that can immediately or soon disable or kill a bug or insect upon contact. The insecticide can be formulated as a film, layer; gel, paste, liquid, solid or other format to be applied to one or more surfaces of the bug trap device. Preferably, the insecticide is contained within the trap portion 14, 114 to prevent inadvertent transfer to a surface, user or others. In a preferred embodiment, the insecticide is formulated in combination with the sticky material or applied as a layer or film or deposit to the sticky material or mass. This combination ensures both capturing and disposing of the bug or insect.

I claim:

1. A bug catching device, comprising:
a handle having a gripping end and a connection end;
a bug catching lid-shaped trap connected to said connection end of said handle, said handle being connected at an incline relative to an upper side of said lid-shaped trap, said lid-shaped trap having a lower rim defining an opening into said lid-shaped trap, said lid-shaped trap being oriented relative to said handle so that a user can position said opening into said lid-shaped trap to initially face a surface on which a bug to be caught is located so as to then trap the bug within said lid-shaped trap when said lid-shaped trap is position over the bug trapping the bug between the lid-shaped trap and the surface; and
a retaining device for retaining the bug within said lid-shaped container after the lid-shaped container is placed over the bug by the user.

2. A bug catching device, comprising:
a handle having a gripping end and a connection end;
a bug catching container connected to said connection end of said handle, said handle being connected at an upper side of said container, said container having a lower opening leading into a bag receiver disposed within said container, said container being oriented relative to said handle so that a user can position said opening into said container to initially face a surface on which a bug to be caught is located so as to then trap the bug within said bug receiver of said container when said container is position over the bug trapping the bug within said bug receiver of said container; and
a retaining device for retaining the bug within said bug receiver of said container after said container is placed over the bug by the user.

3. A bug catching device, comprising:
a handle;
a bug catching trap connected to said handle, said trap having a lower opening extending into a bug receiver disposed within said trap, said trap being oriented relative to said handle so that a user can position said opening into said trap to initially face a surface on which a bug to be caught is located so as to then trap the bug within said trap when said opening is said trap is positioned over the bug trapping the bug within said bug receiver of said trap, said bug receiver being sufficiently dimensionally shaped and size to accommodate and trap a bug within said bug receiver without physically damaging the bug; and
a retaining device for retaining the bug within said lid-shaped container after the lid-shaped container is placed over the bug.

4. A device according to claim 1, wherein said retaining device includes sticky material disposed within said lid-shaped trap.

5. A device according to claim 5, wherein said sticky material is applied to at least one inner surface of said lid-shaped trap.

6. A device according to claim 4, wherein said sticky material is defined by a sticky mass connected to an inner surface of said lid-shaped trap.

7. A device according to claim 6, wherein said sticky mass is centered within said lid-shaped trap.

8. A device according to claim 6, wherein said sticky mass is a three-dimensional shaped mass configured to contact with the bug when the bug is captured with said lid-shaped trap.

9. A device according to claim 8, wherein said sticky mass is shaped with at least one protrusion configured to contact the bug.

10. A device according to claim 9, wherein said sticky mass is provided with a plurality of fingers configured to contact and grip the bug.

11. A device according to claim 4, wherein said sticky material is defined by a layer of sticky material applied within said lid-shaped container.

12. A device according to claim 11, wherein said sticky layer is provided on an inner surface and sides of the lid-shaped trap and sufficiently thick so that the bug is pressed into said sticky layer when the lid-shaped container is placed over the bug and pressed against the surface.

13. A device according to claim 1, including an insecticide associated with said device.

14. A device according to claim 13, wherein said insecticide is located within said lid-shaped trap.

15. A device according to claim 4, wherein insecticide is associated with said sticky material.

16. A device according to claim 15, wherein said insecticide is formulated with said sticky material.

17. A device according to claim 1, wherein said retaining device includes a slidable trap door configured to open and close said opening into said lid-shaped trap.

18. A device according to claim 17, wherein said slidable trap door is actuated by a finger grip provided on said handle.

19. A device according to claim 18, wherein a slidable member connects between said finger grip and said slidable trap door.

20. A device according to claim 17, wherein said slidable trap door includes a spring to bias said slidable door closed.
